(19) United States
(12) Patent Application Publication
(10) Pub. No.: US 2010/0258231 A1
(43) Pub. Date: Oct. 14, 2010

(54) PNEUMATIC TIRE

(75) Inventor: Daichi NAKAMURA, Hiratsuka-shi (JP)

Correspondence Address: HAMRE, SCHUMANN, MUELLER & LARSON, P.C., P.O. BOX 2902, MINNEAPOLIS, MN, 55402-0902, US

(73) Assignee: THE YOKOHAMA RUBBER CO., LTD., Tokyo (JP)

(21) Appl. No.: 12/756,787

(22) Filed: Apr. 8, 2010

(30) Foreign Application Priority Data
Apr. 10, 2009 (JP) 2009-095682

(51) Int. Cl. B60C 13/02

(52) U.S. Cl. 152/523

(57) ABSTRACT

A pneumatic tire includes: a decorative portion formed on an external surface of a sidewall portion so as to extend in a tire circumferential direction, wherein the decorative portion including: a first belt decorative portion having a first ridge arrangement density and a first ridge inclination direction; and a second belt decorative portion having a second ridge arrangement density that is lower than the first ridge arrangement density and a second ridge inclination direction that is different from the first ridge inclination direction, wherein the first belt decorative portion and the second belt decorative portion are disposed to be adjacent to each other in a tire radial direction to share a boundary, and wherein 10% or more of the ridges of the first belt decorative portion are formed to be discontinuous with the ridges of the second belt decorative portion at the boundary.

### CROSS-REFERENCE TO THE RELATED APPLICATION(S)

The present disclosure relates to the subject matters contained in Japanese Patent Application No. 2009-095682 filed on Apr. 10, 2009, which are incorporated herein by reference in its entirety.

### BACKGROUND

1. Field

The present invention relates to a pneumatic tire having a decorative portion formed on an external surface of a sidewall portion where minute ridges are arranged substantially parallel to one another.

2. Description of the Related Art

In a pneumatic tire, splicing portions where circumferential end portions of carcass layers are overlapped to be spliced and turned end portions in a tire radial direction appear as local irregular surfaces. These irregular surfaces may deteriorate an aesthetic quality of the tire. As a conventional technique for making these local irregular surfaces inconspicuous, there is a technique, as illustrated in FIG. 6, in which a belt decorative portion 3 is formed on an external surface of a sidewall portion 2 along a circumferential direction of a tire where a large number of minute ridges referred to as so-called serrations are arranged. An example of such configuration is disclosed in JP-A-2004-299662.

However, the serrations are normally arranged in a ring portion on the outer surface of the sidewall portion by forming straight-line minute ridges thereon. Because of this, stress tends to be concentrated to recess portions between the ridges to facilitate the generation of cracks in association with repeated deformation of the sidewall portion when the tire is in use. Moreover, since the cracks thus generated grow along the recesses, the cracks may become one of causes that reduces the durability of the tire.

The inventor of the present invention has made several detailed studies on methods for making irregular portions appearing on outer surfaces on sidewall portions inconspicuous by disposing a belt decorative portion which is configured by a group of minute ridges. As a result, it has been verified that the camouflaging effect is increased by disposing, as the belt decorative portion, a plurality of belt decorative portions which are different in ridge disposition density or ridge inclination angle from each other, as described in JP-A-11-198614, in combination in a tire radial direction rather than disposing one type of belt decorative portion in which its ridge disposition density and ridge inclination angle are the same.

As a form of combination used in such a case, it is important that adjacent belt decorative portions are disposed so as to be in contact with each other via a boundary. It has also been verified that the camouflaging effect is reduced when belt decorative portions are combined so as to be adjacent to each other with a belt-like area having no design interposed therebetween, as proposed in JP-A-9-315111.

In the pneumatic tire described in JP-A-11-198614, however, although the camouflaging effect of camouflaging the irregular portions is increased, since the ridges making up the belt decorative portion extend while forming a bent portion in the tire radial direction, stress resulting from repeated deformation of the sidewall portion is concentrated, leading to a problem that cracks are generated in the recess portions between the ridges to thereby reduce the life of a tire.

### SUMMARY

One of objects of the present invention is to provide a pneumatic tire having a decorative portion formed on an external surface of a sidewall portion where minute ridges substantially parallel, wherein the generation and growth of cracks in recess portions on the decorative portion are suppressed to thereby increase its durability while making irregular surfaces generated on the sidewall portion inconspicuous.

According to an aspect of the invention, there is provided a pneumatic tire including: a decorative portion formed on an external surface of a sidewall portion so as to extend in a tire circumferential direction, the decorative portion comprising a plurality of ridges that are arranged to be in parallel with one another and spaced apart from one another to have minute gaps therebetween, wherein the decorative portion includes: a first belt decorative portion having a first ridge arrangement density and a first ridge inclination direction; and a second belt decorative portion having a second ridge arrangement density that is lower than the first ridge arrangement density and a second ridge inclination direction that is different from the first ridge inclination direction, wherein the first belt decorative portion and the second belt decorative portion are disposed to be adjacent to each other in a tire radial direction to share a boundary, and wherein 10% or more of the ridges of the first belt decorative portion are formed to be discontinuous with the ridges of the second belt decorative portion at the boundary.

### BRIEF DESCRIPTION OF THE DRAWINGS

A general configuration that implements the various feature of the invention will be described with reference to the drawings. The drawings and the associated descriptions are provided to illustrate embodiments of the invention and not to limit the scope of the invention.

FIG. 1 is a side view showing an example of a pneumatic tire according to an embodiment of the invention.

FIG. 2 is an enlarged plan view showing a portion indicated by reference character R in FIG. 1.

FIG. 3 is a sectional view taken along a III-III line and viewed in a direction indicated by arrows indicating the line in FIG. 2.

FIGS. 4A and 4B are sectional views, corresponding to FIG. 3, which show other embodiments.

FIG. 5 is a sectional view taken along a recess portion lying between ridges at a boundary between belt decorative portions according to a further embodiment.

FIG. 6 is a partially cutaway perspective view of a conventional tire in which a decorative portion is formed on a sidewall portion.

### DETAILED DESCRIPTION OF THE EMBODIMENTS

Hereinafter, embodiments of the invention will be described with reference to the drawings. In the following description, the same or similar components will be denoted by the same reference numerals, and the duplicate description thereof will be omitted. The scope of the claimed invention should not be limited to the examples illustrated in the drawings and those described below.

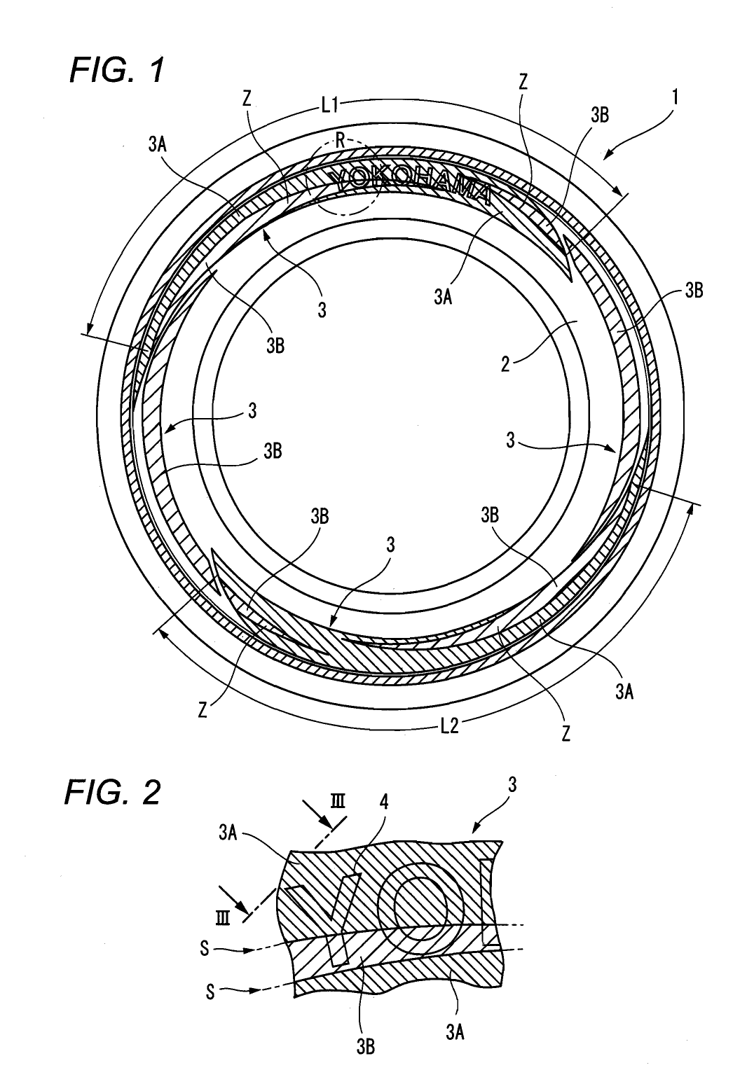

FIG. 1 is a side view showing an example of a pneumatic tire according to an embodiment of the invention. FIG. 2 is an enlarged plan view of a portion indicated by reference character R in FIG. 1.

In FIG. 1, a pneumatic tire 1 according to the embodiment has a decorative portion 3 formed on an external surface of a sidewall portion 2 so as to extend in a tire circumferential direction. The decorative portion 3 is formed with a plurality of ridges which are arranged substantially parallel and spaced apart from each other with minute gaps defined therebetween. The decorative portion 3 is configured by a plurality of (two in the figure) belt decorative portions 3A, 3B which are different in ridge arrangement density and ridge inclination direction from each other.

In the pneumatic tire 1 according to the embodiment, as is shown in FIG. 2, the belt decorative portions 3A, 3B, which are different from each other, are disposed adjacent to each other in a tire radial direction so as to be in contact with a boundary S therebetween, and 10% or more or preferably 50% or more of ridges of the belt decorative portion 3A having a higher ridge arrangement density are made to be discontinuous with the ridges of the belt decorative portion 3B having a lower ridge arrangement density at the boundary S where the plurality of belt decorative portions 3A, 3B meet.

The belt decorative portions 3A and the belt decorative portion 3B are disposed to be adjacent to each other to share the boundary S.

The decorative portion 3, which is formed on the external surface of the sidewall portion 2, is configured by the plurality of belt decorative portions 3A, 3B which are different from each other in ridge arrangement density and ridge inclination direction, and these belt decorative portions 3A, 3B, which are different from each other, are disposed so as to be adjacent in the tire radial direction via the boundary S where they meet. According to this arrangement, irregular surfaces which are caused on the sidewall portion 2 by splicing portions where carcass layers are spliced together can be made inconspicuous with good efficiency.

Moreover, 10% or more of the ridges of the belt decorative portion 3A having the higher ridge arrangement density are made to be discontinued from the ridges of the belt decorative portion 3B having the lower ridge arrangement density at the boundary S where the different belt decorative portions 3A, 3B lie adjacent to each other in the tire radial direction. According to this arrangement, stress applied to the ridges as a result of repeated deformation of the sidewall portion 2 at the boundary S where the adjacent belt decorative portions 3A, 3B meet is distributed to the respective ridges of the different belt decorative portions 3A, 3B, whereby the generation of cracks at recess portions between the ridges is suppressed with good efficiency, thereby making it possible to increase the durability of the tire.

In the embodiment shown in FIG. 1, while the portion where the belt decorative portions 3A, 3B lie adjacent to each other in the tire radial direction via the boundary S where they meet is described as being disposed at a circumferential portion of the sidewall portion 2, the pneumatic tire 1 of the invention is not limited to the form of arrangement of the belt decorative portions 3A, 3B resulting when viewed from the top, the form of combination of them and the form of disposition thereof at the portion where they lie adjacent to each other. Thus, the portion where the belt decorative portions 3A, 3B lie adjacent to each other may be disposed continuously along the full circumference of the sidewall portion 2.

Further, the number of belt decorative portions that configures the decorative portion 3 is not limited to that described in the embodiment, and hence, the number of belt decorative portions can appropriately set in accordance with a type and size of a tire or a width of a decorative portion 3 which is formed on the external surface of the side wall portion 2. In addition, in the pneumatic tire 1 according to the embodiment, the portion where the belt decorative portions 3A, 3B lie adjacent to each other is preferably formed on a portion of a surface of the sidewall portion 2 which corresponds to a position where circumferential end portions of carcass layers are spliced or radial sides thereof are turned over.

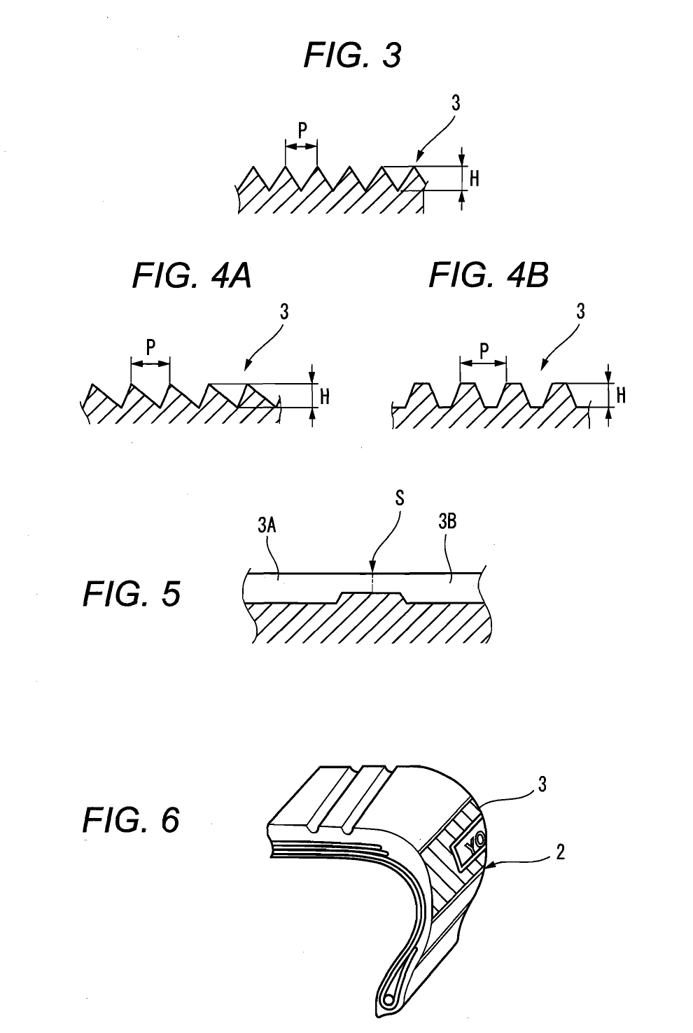

Here, there is imposed no special limitation on the form of ridges that are formed on the decorative portion 3. However, the ridges can be formed into sawtooth serrations in which each serration takes the form of a regular triangle in section as is shown in FIG. 3. In addition to this, the ridges can be formed into triangular serrations in which inclinations of left and right slopes of each serration are made to differ as is shown in FIG. 4A, or the ridges can be formed into trapezoidal serrations as is shown in FIG. 4B.

In the pneumatic tire 1 according to the embodiment, a configuration may be adopted in which the ridges have a height H of 0.2 mm to 1.0 mm and a pitch at which the ridges are arranged of 0.4 mm to 1.4 mm or preferably 0.75 mm to 0.95 mm at the decorative portion 3A having the higher ridge arrangement density and a pitch of 0.7 mm to 1.7 mm or preferably 1.1 mm to 1.3 mm at the decorative portion 3B having the lower ridge arrangement density.

Here, in the event that the height H of the ridges is less than 0.2 mm, the irregular portion at the ends of the carcass layers becomes conspicuous easily, whereas in the event that the height exceeds 1.0 mm, cracks are easy to be generated at recess portions between the ridges at the boundary S where the belt decorative portions 3A, 3B lie adjacent to each other. In addition, by the pitch at which the ridges are arranged being set to fall within the ranges described above, stress concentrated to the recess portions as a result of repeated deformation of the sidewall portion 2 can be distributed with good efficiency, thereby making it possible to suppress the generation of cracks at the boundary S between the belt decorative portions 3A, 3B.

Further, it is preferable that an inclination angle at which the ridges are inclined relative to the tire radial direction is set to a range from 25 degrees to 70 degrees or preferably to a range from 40 degrees to 50 degrees. By adopting this configuration, the generation of cracks at the boundary between the belt decorative portions 3A, 3B can be suppressed more efficiently.

In the pneumatic tire 1 according to the embodiment, from the viewpoint of ensuring the durability of the tire, the belt decorative portions 3A, 3B, which lie adjacent in the tire radial direction, are preferably disposed so as to extend along the full circumference of the sidewall portion 2. However, from the viewpoint of ensuring the aesthetic appearance of the sidewall portion 2 and reducing the fabrication costs of molds, as is shown in FIG. 1, the belt decorative portions 3A, 3B can be disposed partially along the circumferential direction of the sidewall portion 2.

In this configuration, a total length L1+L2 (refer to FIG. 1) in the tire circumferential direction of the boundary S where the belt decorative portions 3A, 3B meet in the tire radial direction is made to be 20% or more or preferably 30% or more an outer circumferential length of the tire. By adopting this configuration, the reduction in durability of the tire can be suppressed.

In the pneumatic tire 1 according to the embodiment, as is shown in FIG. 5, a bottom-raised portion 5 may be formed in recess portions between the ridges of the adjacent belt decorative portions 3A, 3B so as to straddle the boundary S at the boundary S where the adjacent belt decorative portions 3A, 3B meet in the tire radial direction. As this occurs, the bottom-raised portion may have a height which ranges from 10 to 60% the height H of the ridges at the adjacent belt decorative portions 3A, 3B. By adopting this configuration, the generation of cracks at the recess portions between the ridges at the boundary S between the adjacent belt decorative portions 3A, 3B.

In the pneumatic tire 1 according to the embodiment, the height H of the ridges can be made to differ between the belt decorative portions 3A, 3B. According to this configuration, from the viewpoint of ensuring the aesthetic appearance of the decorative portion 3, the heights H of the ridges which are made to differ are preferably changed so as to be equal to each other as the ridges extend towards the boundary S where the adjacent belt decorative portions 3A, 3B meet.

In the pneumatic tire 1 according to the embodiment, as is shown in FIGS. 1 and 2, a marking made up of letters and patterns is formed on the surface of the decorative portion 3. This marking 4 may be formed by a recess groove which bites into the ridges on the decorative portion 3 and straddles between the adjacent ridges.

Thus, as has been described heretofore, the pneumatic tire of the invention adopts the configuration in which the decorative portion formed on the external surface of the sidewall portion is configured by the plurality of belt decorative portions which are made different from each other in ridge arrangement density and ridge inclination direction, these belt decorative portions are disposed so as to lie adjacent to each other in the tire radial direction and 10% or more of the ridges of the belt decorative portion 3A having the higher ridge arrangement density are made to be discontinued from the ridges of the belt decorative portion 3B having the lower ridge arrangement density at the boundary S where the different belt decorative portions 3A, 3B lie adjacent to each other in the tire radial direction. By adopting this configuration, the generation of cracks at the recess portions between the ridges at the boundary between the adjacent belt decorative portions is suppressed with good efficiency while making inconspicuous the irregular surfaces which are formed on the sidewall portion by the splicing portions where the carcass layers are spliced together, thereby making it possible to increase the durability of the tire. Thus, the pneumatic tire according to the embodiment can provide the superior advantage while being made simple in construction and therefore can be applied widely to various types of tires including those for passenger cars.

A conventional tire and a tire according to the invention are built. The conventional tire is given a tire size expressed as 215/60R16. In the conventional tire, a decorative portion 3 was formed to have a single belt decorative portion 3A, and this belt decorative portion 3A was disposed into a ring so as to extend along the full circumference of a sidewall portion 2. In the tire according to the invention, a decorative portion 3 was made up of belt decorative portions 3A, 3B, and these belt decorative portions 3A, 3b were disposed as is shown in FIG. 1.

The respective decorative portions 3 of the conventional tire and the tire of the embodiment were given a cross section as is shown in FIG. 3. In both the tires, ridges were given a height of 0.3 mm and pitches P at which the ridges were disposed or arranged were 0.85 mm at the belt decorative portion 3A and 1.2 mm at the belt decorative portion 3B. Inclination angles of the ridges relative to the tire radial direction were −45 degrees at the belt decorative portion 3A and +45 degrees at the belt decorative portion 3B.

Irregular surfaces appearing on surfaces of the sidewall portions 2 of these two types of tires were observed for comparison to find out that irregular surfaces, although they were slight, appeared along the full circumference of the conventional tire, whilst almost no irregular surface appeared on the pneumatic tire according to the embodiment.

Further, the respective tires were evaluated on durability. To do this, in the conventional tire, cuts which were each 1.5 mm deep and 5.0 mm long were formed at recess portions between the ridges in four positions on the decorative portion 3 which were located circumferentially of the tire (at equal intervals). In the tire of the invention, similar cuts were formed at (four) recess portions between the ridges at the belt decorative portion 3B which is indicated by reference character Z in FIG. 1. Thereafter, the respective tires were inflated to an air pressure of 120 kPa, a load corresponding to 88% of their maximum load capacity was applied to the respective tires by an inside drum testing machine, and the tires were kept rolling continuously over 62 hours at 81 km/h. Both the tires were individually measured for growth rate of the cut.

The result of the measurement showed that the length of the cut grew 15% to 20% towards both the sides in the conventional tire, whilst the growth of length of the cut was stopped at the boundary S with the belt decorative portion 3A at every measured position in the tire of the invention. It was confirmed from the result of the measurement that the growth of cracks at the recess portions between the ridges at the decorative portion 3 was suppressed in the tire according to the embodiment compared with the conventional tire.

It is to be understood that the present invention is not limited to the specific embodiment described above and that the present invention can be embodied with the components modified without departing from the spirit and scope of the present invention. The present invention can be embodied in various forms according to appropriate combinations of the components disclosed in the embodiments described above. For example, some components may be deleted from the configurations described as the embodiment.

What is claimed is:

1. A pneumatic tire comprising:
a decorative portion formed on an external surface of a sidewall portion so as to extend in a tire circumferential direction, the decorative portion comprising a plurality of ridges that are arranged to be in parallel with one another and spaced apart from one another to have minute gaps therebetween,
wherein the decorative portion comprises:
a first belt decorative portion having a first ridge arrangement density and a first ridge inclination direction; and
a second belt decorative portion having a second ridge arrangement density that is lower than the first ridge arrangement density and a second ridge inclination direction that is different from the first ridge inclination direction,
wherein the first belt decorative portion and the second belt decorative portion are disposed to be adjacent to each other in a tire radial direction to share a boundary, and
wherein 10% or more of the ridges of the first belt decorative portion are formed to be discontinuous with the ridges of the second belt decorative portion at the boundary.

2. The pneumatic tire according to claim 1,
wherein the ridges of the first belt decorative portion and the second belt decorative portion are formed to have a height in a range from 0.2 mm to 1.0 mm,
wherein the ridges of the first belt decorative portion are arranged to have a first pitch in a range from 0.4 mm to 1.4 mm, and
wherein the ridges of the second belt decorative portion are arranged to have a second pitch in a range from 0.7 mm to 1.7 mm.

3. The pneumatic tire according to claim 1,
wherein the first ridge inclination direction and the second ridge inclination direction with respect to the tire radial direction are set to be in a range from 25 degrees to 70 degrees.

4. The pneumatic tire according to claim 1,
wherein a total length of the boundary in the tire circumferential direction is set to be 20% or more of an outer circumferential length of the tire.

5. The pneumatic tire according to claim 1 further comprising:
a bottom-raised portion that is formed in recess portions between the ridges of the first belt decorative portion and the second belt decorative portion at a position straddling the boundary.

6. The pneumatic tire according to claim 5,
wherein the bottom-raised portion is formed to have a height that is in a range from 10% to 60% of the height of the ridges.

7. The pneumatic tire according to claim 1,
wherein the ridges of the first belt decorative portion and the ridges of the second belt decorative portion are formed to have different height except at the boundary.
